(19) United States
(12) Patent Application Publication
(10) Pub. No.: US 2017/0288437 A1
(43) Pub. Date: Oct. 5, 2017

(54) NVB TRICKLE-CHARGER SYSTEM WITH BUILT-IN AUTO-DUMMY-LOAD USING SI-MOS-SUB-VTH MICRO-POWER PYROELECTRICITY

(71) Applicant: BOARD OF REGENTS OF THE UNIVERSITY OF TEXAS SYSTEM, Austin, TX (US)

(72) Inventors: Shuza Binzaid, San Antonio, TX (US); Amar S. Bhalla, Helotes, TX (US); Ryan Guo, Helotes, TX (US); MD Qumrul Hasan, Las Cruces, NM (US)

(21) Appl. No.: 15/506,742

(22) PCT Filed: Aug. 26, 2015
(86) PCT No.: PCT/US15/47063

§ 371 Date: Feb. 26, 2017

Related U.S. Application Data
(60) Provisional application No. 62/042,212, filed on Aug. 26, 2014.

(51) Int. Cl. H02J 7/00; H02M 1/14; H02N 10/00; H02J 7/34

(52) U.S. Cl. CPC H02J 7/0065; H02J 7/34; H02M 1/14; H02N 10/00

(57) ABSTRACT

Disclosed herein is a device, system, and method for a trickle charging system of non-inductive voltage boost (NVB) converter with built-in auto-dummy-load (ADL) for wide-range of charge storage devices i.e. small button-cell type batteries and super-caps using micro power pyro-electricity at Si-MOS sub-threshold voltage. A VLSI configuration of the system is also disclosed in embodiments. The system converts the pyro-electric material at MOS sub-threshold 0.37V for optimizing to the battery charging level at 1.45V. This system was proven at hardware level and found to be 98.8% power efficient. The designed IC can charge independently without any external components for up to 1 uW max, but able to charge up to 20 uA with external components. Thus it is considered to be a very versatile design.

### CROSS-REFERENCE TO RELATED APPLICATIONS

This application claims priority to, and is the National Stage of International Application No. PCT/US15/47063 filed on Aug. 26, 2015 and claims priority of U.S. Provisional Patent Application Ser. No. 62/042,212, filed on Aug. 26, 2014, the contents of which are incorporated by reference in their entirety.

### STATEMENT REGARDING FEDERALLY SPONSORED RESEARCH OR DEVELOPMENT

This invention was made with government support under grant no. 1002380 and grant no. 0844081 awarded by the National Science Foundation. The government has certain rights in the invention.

### FIELD OF THE INVENTION

The present invention generally relates to a device, system and method for trickle charging.

### BACKGROUND OF THE INVENTION

Batteries provide electrical energy through an electro-chemical process. Batteries are made-up of one or more cells in series or parallel combinations to increase voltage and output capacity.

The electro-chemical cells consists of two terminals suspended in an electrolyte. The terminals are called the anode (−) and the cathode (+). An electrical current is essentially a flow of electrons, and the battery can be regarded as an electron pump. The chemical reaction between the anode and the electrolyte forces electrons out of the electrolyte and into the anode metal, through the circuit, then back to the cathode. From the cathode metal, the electrons re-enter the electrolyte. This direction may seem strange, from negative to positive. We regard ‘current’ as flowing from positive down to negative, but in fact; this current is a flow of electrons in the opposite direction. The anode and cathode both get converted during this reaction, one is eaten away, and the other has a build-up of material on it. When a rechargeable battery is recharged, this chemical reaction is reversed, and the terminals are restored. [4]

Batteries can be divided into two classes: primary and secondary. Primary batteries are designed for a single discharge cycle only, non-rechargeable. Secondary cells are designed to be recharged, typically, up to 1000 times.

Primary batteries or primary cells can produce current immediately on assembly. These are most commonly used in portable devices that have low current drain, are used only intermittently, or are used well away from an alternative power source, such as in alarm and communication circuits where other electric power is only intermittently available. Disposable primary cells cannot be reliably recharged, since the chemical reactions are not easily reversible and active materials may not return to their original forms. Battery manufacturers recommend against attempting recharging primary cells. In general, these have higher energy densities than rechargeable batteries, but disposable batteries do not fare well under high-drain applications with loads. [13]

Secondary batteries, also known as secondary cells, or rechargeable batteries, must be charged before first use; they are usually assembled with active materials in the discharged state, various types of batteries are shown in FIG. 1. Rechargeable batteries are recharged by applying electric current, which reverses the chemical reactions that occur during use. Devices to supply the appropriate current are called chargers.[13]

A battery's characteristics may vary over load cycle, over charge cycle, and over lifetime due to many factors including internal chemistry, current drain, and temperature. A battery's capacity is the amount of electric charge it can deliver at the rated voltage. The more electrode material contained in the cell the greater its capacity. A small cell has less capacity than a larger cell with the same chemistry, although they develop the same open-circuit voltage. The fraction of the stored charge that a battery can deliver depends on multiple factors, including battery chemistry, the rate at which the charge is delivered (current), the required terminal voltage, the storage period, ambient temperature and other factors. The higher the discharge rate, the lower the capacity. The non linear relationship between current, discharge time and capacity for a lead acid battery is approximated (over a typical range of current values) by Peukert's law:

$$t = \frac{{Q}_{P}}{{I}^{k}}$$

### Where,

Q_{P} is the capacity when discharged (non linear)
I is the current drawn from battery (micro-Amps).
t is the amount of time (in hours) that a battery can sustain.
k is a constant around 1.3.

Internal energy losses and limitations on the rate that ions pass through the electrolyte cause battery efficiency to vary. Above a minimum threshold, discharging at a low rate delivers more of the battery's capacity than at a higher rate. [13]

The circuitry to recharge the batteries in a portable product is an important part of any power supply design. The complexity (and cost) of the charging system is primarily dependent on the type of battery and the recharge time.

In the realm of battery charging, charging methods are usually separated into two general categories: Fast charge is typically a system that can recharge a battery in about one or two hours, while slow charge usually refers to an overnight recharge (or longer).

Slow charge is usually defined as a charging current that can be applied to the battery indefinitely without damaging the cell this method is sometimes referred to as a trickle charging. The maximum rate of trickle charging which is safe for a given cell type is dependent on both the battery chemistry and cell construction. When the cell is fully charged, continued charging causes gas to form within the cell. All of the gas formed must be able to recombine internally, or pressure will build up within the cell eventually leading to gas release through opening of the internal vent which reduces the life of the cell.

This means that the maximum safe trickle charge rate is dependent on battery chemistry, but also on the construction of the internal electrodes. This has been improved in newer cells, allowing higher rates of trickle charging.

The big advantage of slow charging is that it is the charge rate that requires no end-of-charge detection circuitry, since it cannot damage the battery regardless of how long it is used. The big disadvantage of slow charge is that it takes a long time to recharge the battery, which is a negative marketing feature for a consumer product. [2]

Fast charge for Ni—Cd and Ni-MH is usually defined as a 1 hour recharge time, which corresponds to a charge rate of about 1.2 c. The vast majority of applications where Ni—Cd and Ni-MH are used do not exceed this rate of charge. It is important to note that fast charging can only be done safely if the cell temperature is within 10-40° C., and 25° C. is typically considered optimal for charging. Fast charging at lower temperatures (10-20° C.) must be done very carefully, as the pressure within a cold cell will rise more quickly during charging, which can cause the cell to release gas through the cell's internal pressure vent (which shortens the life of the battery). The chemical reactions occurring within the Ni—Cd and Ni-MH battery during charge are quite different:

The Ni—Cd charge reaction is endothermic (meaning it makes the cell get cooler), while the Ni-MH charge reaction is exothermic (it makes the cell heat up). The importance of this difference is that it is possible to safely force very high rates of charging current into a Ni—Cd cell, as long as it is not overcharged. The factor which limits the maximum safe charging current for Ni—Cd is the internal impedance of the cell, as this causes power to be dissipated by P=I²R. The internal impedance is usually quite low for Ni—Cd, hence high charge rates are possible.

When the battery reaches full charge, the energy being supplied to the battery is no longer being consumed in the charge reaction, and must be dissipated as heat within the cell. This results in a very sharp increase in both cell temperature and internal pressure if high current charging is continued.

The cell contains a pressure-activated vent which should open if the pressure gets too great, allowing the release of gas (this is detrimental to the cell, as the gas that is lost can never be replaced). In the case of Ni—Cd, the gas released is oxygen. For Ni-MH cells, the gas released will be hydrogen, which will burn violently if ignited.

A severely overcharged cell can explode if the vent fails to open due to deterioration with age or corrosion from chemical leakage. For this reason, batteries should never be overcharged until venting occurs. [2]

The actual capacity of a battery depends upon a number of factors, including operating temperature, discharge current, and battery age.

Temperature is also one of the factors to reduce battery rating. Below 25° C. temperature, and also far above it, they will operate less efficiently that are shown in FIG. 2.

At the higher the temperature, the greater the corrosion rate and the sooner the failure of the battery. This accelerated corrosion at higher temperatures occurs regardless of the charge current flowing into the battery. However, since higher temperatures give rise to increased currents at a given voltage setting, the net result of an elevated battery ambient temperature is to intensify the negative effects on the battery. [4]

In an ideal battery, the terminal voltage would be constant over the whole discharge time, until when the battery is finally fully discharged, the voltage would drop right down (although this could make battery level detection quite hard). However, in real batteries, the terminal voltage decreases as the charge reduces that are shown in FIG. 3. ^{[4]}

In a normal DC power supply the output is capacitive smoothed, and often regulated. However, the battery itself provides the smoothing in this scheme, and regulation is unnecessary. The battery is then charged with a constant voltage, although it has a large AC content (ripple) on top of it. This ripple is a contributing factor to the shortening of the battery's life, and ideally should be removed.

In a constant voltage scheme, the current is dictated by either the battery itself, or by a current limit in the charger, and the voltage is maintained constant. When the battery is initially discharged, its terminal voltage might be quite low, this would cause a very large in rush current at the start of charging that are shown in FIG. 4. [4]

As the battery charges up, its terminal voltage increases, and the internal resistance decreases. Eventually, when it is fully charged, it will be taking a trickle current from the charge which maintains its fully charged state. In the constant current charging, the current is controlled, and the voltage is allowed to go to whatever value is required to maintain the required current. In the constant current and constant voltage, the battery is first charged with a constant current and then with a fixed voltage.

### BRIEF SUMMARY OF THE INVENTION

Disclosed herein is a “Non-Inductive Voltage Boost Trickle Charger” (NVB-TC) circuit. The device is able to boost pyroelectricity 0.3˜0.4V to 1.45V to charge batteries. In some aspects the DC output is unregulated for discharged to full-charge stages. In some aspects the invention's directional dual current path establishes each stage of voltage step-up. In some aspects the Controlled Ripple DC signal is assured to trickle charging at full-charge stage devices. In yet other aspects step-up voltage is cascaded by a single rail system. In some aspects output voltage is referenced by the common ground. In some aspects inequality of peak voltage is beneficial to produce controlled ripple at full-charge stage. In further aspects output energy is compromised with auto-dummy-load to prevent over-charging.

In some embodiments the invention is a circuit comprising 2CN₀+(3P+2C)N₁+2(P+C)N_{2,m-1}+(3P+2C+R)Nₘ

wherein, C is the charge collector, P is the directional current paths, R is ripple resistance, N is the stage (a letter) and m is the stage position number.

### BRIEF DESCRIPTION OF THE SEVERAL VIEWS OF THE DRAWINGS

For a more complete understanding of the features and advantages of the present invention, reference is now made to the detailed description of the invention along with the accompanying figures in which:

FIG. 1 is Ni-Cad, Ni-MH, Alkaline and super cap cell battery [13, 14 and 15] in accordance with embodiments of the current disclosure.

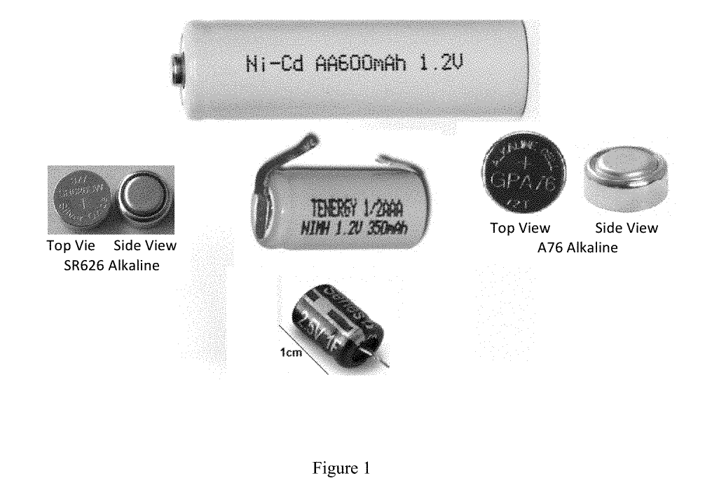

FIG. 2 illustrates Constant Current Discharge [4] in accordance with embodiments of the current disclosure.

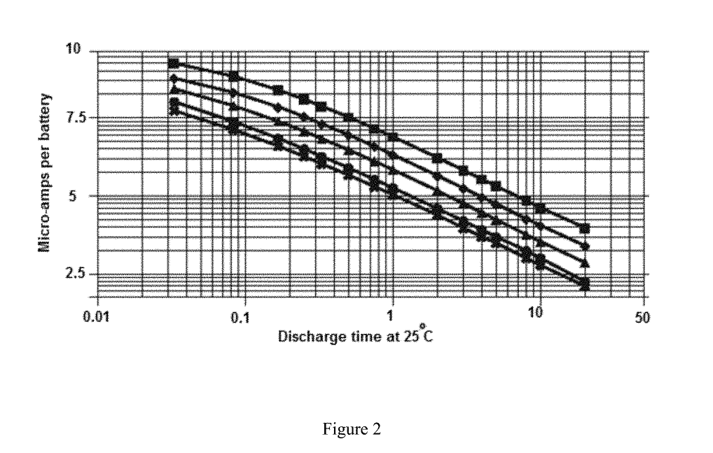

FIG. 3 illustrates typical discharge curves of different batteries [4] in accordance with embodiments of the current disclosure.

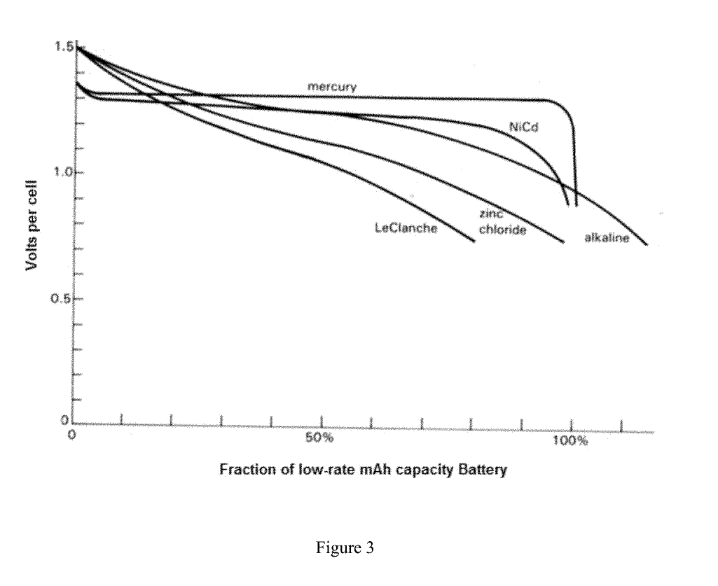

FIG. 4 illustrates Constant Voltage Charging [4] in accordance with embodiments of the current disclosure.

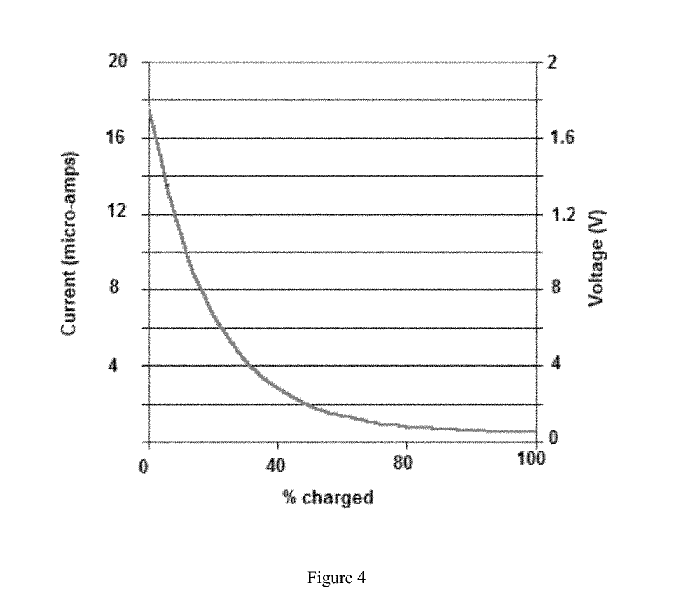

FIG. 5 is a schematic diagram of a single stage NVB-TC in accordance with embodiments of the current disclosure.

FIG. 6 is a 20 pin semiconductor IC design consisting four and three stages of NVB-TC in accordance with embodiments of the current disclosure.

FIG. 7 illustrates a Battery's I-V Curve [4] in accordance with embodiments of the current disclosure.

FIG. 8 illustrates Input and output voltage and current curve of fully discharged battery, with no ripple<85% charged in accordance with embodiments of the current disclosure.

FIG. 9 illustrates an Input and output voltage and current curve respectively 85% charged battery, ripple started 20 mV<90% charged in accordance with embodiments of the current disclosure.

FIG. 10 illustrates an Input and output voltage and current curve respectively 98.5% fully charged battery, ripple 50 mV at 1.45V in accordance with embodiments of the current disclosure.

FIG. 11 is a NVB-Trickle charging circuit setup during the hardware testing with an A76 battery in accordance with embodiments of the current disclosure.

FIG. 12 illustrates Pyro-electric input voltage at NVB-TC at 98% efficiency in accordance with embodiments of the current disclosure.

FIG. 13 illustrates NVB-TC charging output voltage at 1.45V in accordance with embodiments of the current disclosure.

### DETAILED DESCRIPTION OF THE INVENTION

Disclosed herein is a novel Non-Inductive Voltage Boost (NVB) Trickle Charger (NVB-TC) System with Built-In Auto-Dummy-Load (ADL).

From the previous discussion we know that battery's charging-discharging system and slow charging and fast charging methods and so on. Presented now is the trickle charging operation.

Trickle Charging Operation of NVB Converter

Trickle chargers are commonly used to charge batteries of low capacity. This means that it tends to be slower when providing energy to batteries. Because it does not support speedy charging, this kind of chargers can also be used as a maintainer. If the batteries are connected to the chargers for quite a long time, the batteries will not be overheating or getting damaged. So the advantages of trickle charging are:

1. Extends the life of a battery
2. Trickle charges prevent batteries from becoming sulfated
3. No longer need to replace batteries frequently when these trickle chargers are used.

Performance

A Trickle Charging Operation of Non-Inductive Voltage Boost Converter is able to achieve the following performance:

1. Convert low power pyro-voltage to boost at higher voltage.
2. To boost the 0.37V up to 1.45V for charging the battery.
3. Improve current losses.
4. Increase ripple voltages
5. Increases efficiency
6. Extend the life of a battery

VLSI Configuration of the NVB-TC Single IC Chip for Wide-Range of Micro-Power System

First pyroelectric voltage charges the capacitor C1 that is comparatively larger than other cascaded capacitor. After that it added voltage charge with other cascaded capacitor. In this process, we boost our pyroelectric MOS sub-Vth 0.37V to 1.45V.

At the starting period, when battery is fully discharged, the terminal is connected and a very large inrush current at the start of charging is experienced as well as a low unstable output voltage.

At the 85% battery charged condition, low output current and stable output voltage is experienced. In this fully charged condition negligible ripple voltage was experienced.

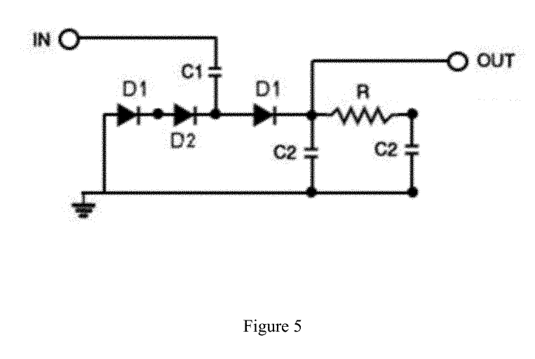

At the 98.5% battery charged condition, very low output current and desired stable output voltage was experienced. This condition is known as fully battery charged condition. In the fully battery charged condition larger ripple voltage is experienced. This is also known as trickle charging operation. R is a variable resistor for compensating the trickle function of the output stage depending upon the type of batteries or storage capacitors. D1 and D2, (similarly, C1 and C2) can be the same device depending upon its size, design structure and the silicon process technology that are shown in FIG. 5. The pin configurations of the 4-stage NVB-TC and 3-stage NVB-TC are shown in Table 3.1 and 3.2 respectively.

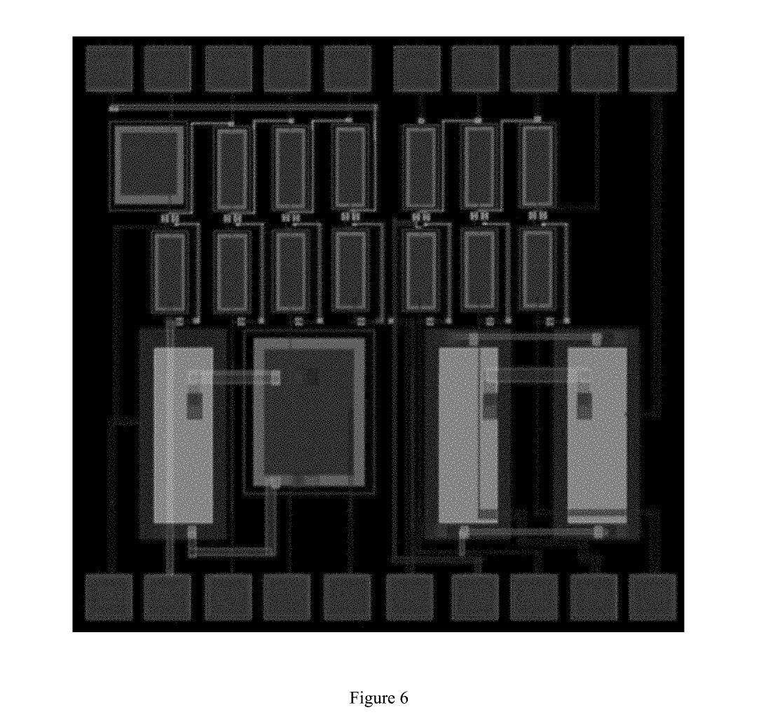

It is configured with scalable technology that is used for shrinkable design and provides smaller architecture and lowering threshold voltage limit. A 20 pin semiconductor IC design consists of four and three stages of NVB-TC are shown in FIG. 6.

TABLE 3.1
Pin configuration of the designed chip 4-stage NVB-TC. Also here
H and L are the upper and lower pins, respectively in the layout.

| Pin # | Pin Name | Module/stage |
|---|---|---|
| H2 | Pyro-electric voltage input | 1^{st} stage |
| H3 | 1^{st} module input | 1^{st} stage |
| H4 | 2^{nd} module input | 2^{nd} stage |
| H5 | 3^{rd} module input | 3^{rd} stage |
| H1 | 4^{th} module input | 4^{th} stage |
| L1 | Common ground | GND 1-4 stages |
| L2 | 1^{st} module output | 1^{st} stage |
| L3 | 2^{nd} module output | 2^{nd} stage |
| L4 | 3^{rd} module output | 3^{rd} stage |
| L6 | 4^{th} module output | 4^{th} stage |
| L5 | Output | Output/Trickle control |

TABLE 3.2
Pin configuration of the designed chip 3-stage NVB-TC. Also here
H and L are the upper and lower pins, respectively in the layout.

| Pin # | Pin Name | Module/stage |
|---|---|---|
| H6 | Pyro-electric voltage input | 1^{st} stage |
| H7 | 1^{st} module input | 1^{st} stage |
| H8 | 2^{nd} module input | 2^{nd} stage |
| H9 | 3^{rd} module input | 3^{rd} stage |
| L7 | Common ground | GND 1-3 stages |
| L8 | 1^{st} module output | 1^{st} stage |
| L9 | 2^{nd} module output | 2^{nd} stage |
| L10 | 3^{rd} module output | 3^{rd} stage |
| H10 | Output | Output/Trickle control |

Configuration Verification of the NVB-TC IC

Pyroelectricity as a power source to design trickle charging NVB converter circuit was utilized. Pyroelectricity is produced by pyro-materials. Pyro-materials material is considered to exhibit the pyroelectric effect when a change in the material's temperature with respect to time (temporal fluctuation) results in the production of electric charge.

A trickle charging NVB converter is an electrical circuit that converts pyro AC electrical power from a lower MOS sub-threshold voltage to a higher DC voltage, typically using a network of capacitors and diode.

Using the trickle charging NVB converter circuit batteries were tested in three ways:

1. Battery Function (Fully Discharged condition)
2. Battery Function (85% Charged condition)
3. Battery Function (98.5% Fully Charged condition)

Battery Function (Fully Discharged): As we know from our previous discussion that when a battery is fully discharged, its terminal voltage must be quite low and the equivalent resistance also be as low. This would cause a very large inrush current at the start of charging.

In the battery's fully discharged function, we consider two conditions one not fully charged condition and another fully charged condition.

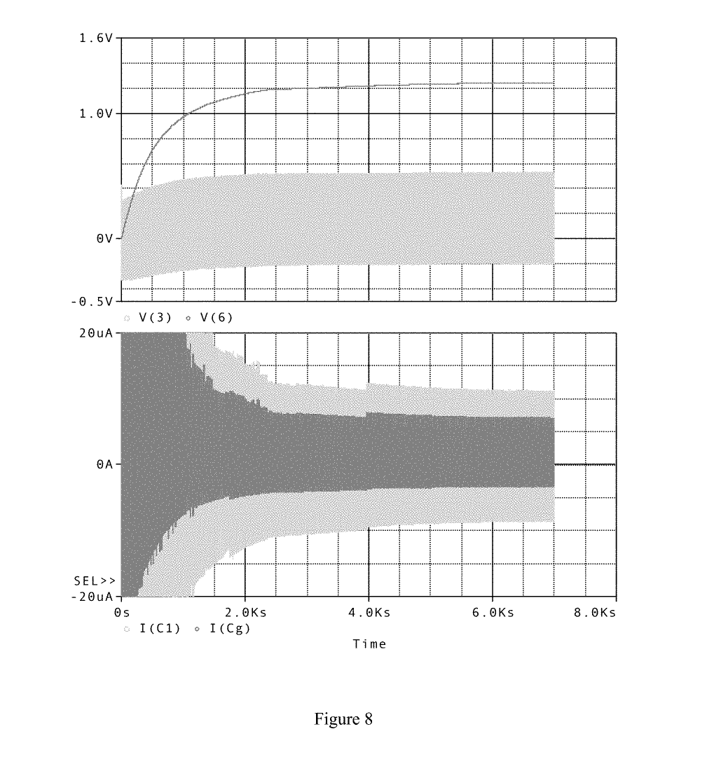

At the not fully charged condition we are taken one-third of the output cycle for our calculation. And we got average output voltage 0.37V and average output current 34 uA. So we got output power at not fully charged condition 12.58 uW. At the same time we got average input voltage 0.74V and average input current 32 uA. So we got input power at not fully charged condition 24.05 uW. In the not fully charged condition circuit power loss is 11.47 uW. At the not fully charged condition circuit efficiency is 52.3% that are shown in FIG. 8.

At the fully charged condition we got average output voltage 1.25V and average output current 10 uA. So we got output power at fully charged condition 12.5 uW. At the same time we got average input voltage 0.74V and average input current 17 uA. So we got input power at fully charged condition 12.65 uW. In the fully charged condition circuit power loss is 0.15 uW. At the fully charged condition circuit efficiency is 98.8%.

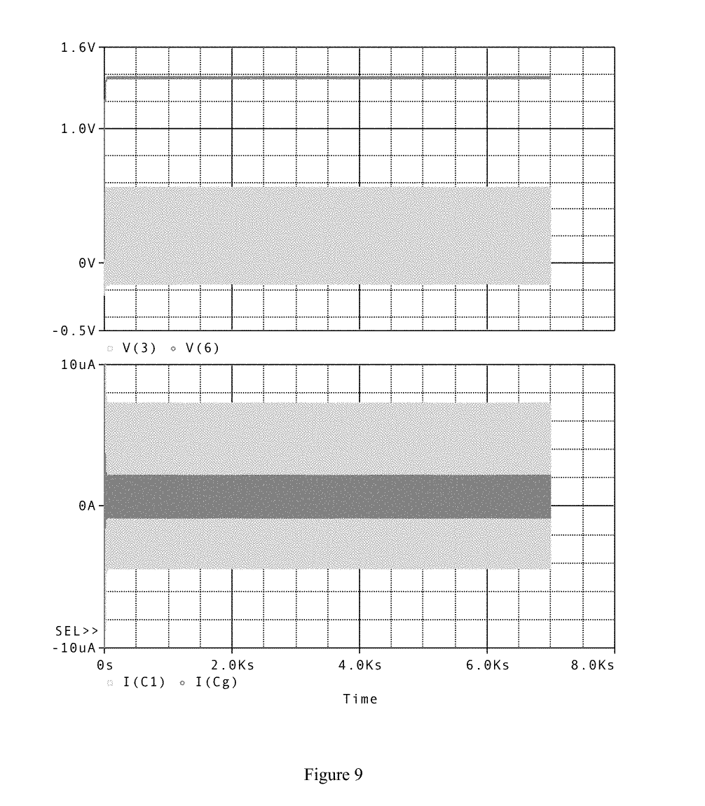

Battery Function (85% Fully Charged): At the 85% fully charged condition we got average output voltage 1.38V and average output current 3.25 uA. So we got output power at 85% fully charged condition 4.485 uW. At the same time we got average input voltage 0.74V and average input current 11.5 uA. So we got input power at 85% fully charged condition 8.51 uW. In the 85% fully charged condition circuit power loss is 4.025 uW. At the 85% fully charged condition circuit efficiency is 52.7% that are shown in FIG. 9.

At 85% fully discharged battery small amount of trickle has started at about 20 mV. Input current is more than battery is using for internal leak/self-discharge mechanism, thus circuit functions as the built-in Auto-Dummy-Load for rest of the current

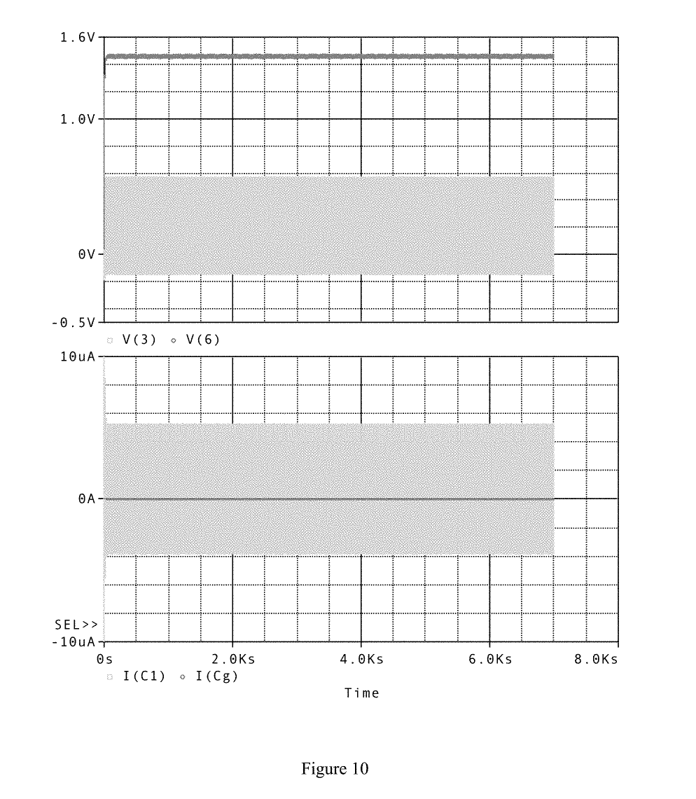

Battery Function (98.5% Fully Charged): As we know from our previous discussion that when a battery is fully charged, the equivalent resistance also becomes high. This would cause a very low current for charging flowing into the battery or capacitor. This is also known as slow charging. This small amount of current resulting in charging process is caused by the trickle charging up to 50 mV at 1.45V that are shown in FIG. 10.

Slow charge is usually defined as a charging current that can be applied to the battery indefinitely without damaging the cell this method is sometimes referred to as a trickle charging.

At the fully charged battery condition 50 mV ripple voltage. At fully charged state it acts as a fully activated built-in Auto-Dummy-Load.

When the cell is fully charged, continued charging causes gas to form within the cell. All of the gas formed must be able to recombine internally, or pressure will build up within the cell eventually leading to gas release through opening of the internal vent which reduces the life of the cell. In the trickle charging the output voltage creates ripple that helps to charge the battery. When battery is fully charged a small amount of current discharged in the reversed path and the same amount of charged entered through ripple voltage.

At the fully charged condition we got average output voltage 1.45V and average output current 2.3 nA. So we got output power at fully charged condition 3.335 nW. At the same time we got average input voltage 0.74V and average input current 8.5 uA. So we got input power at fully charged condition 6.29 uW. In the fully charged condition circuit power loss is 6.286 uW. At the fully charged condition, circuit's efficiency is only 0.0053% as expected and the internal Auto-Dummy-Load (ADL) is fully functional to protect the battery.

NVB-TC Hardware

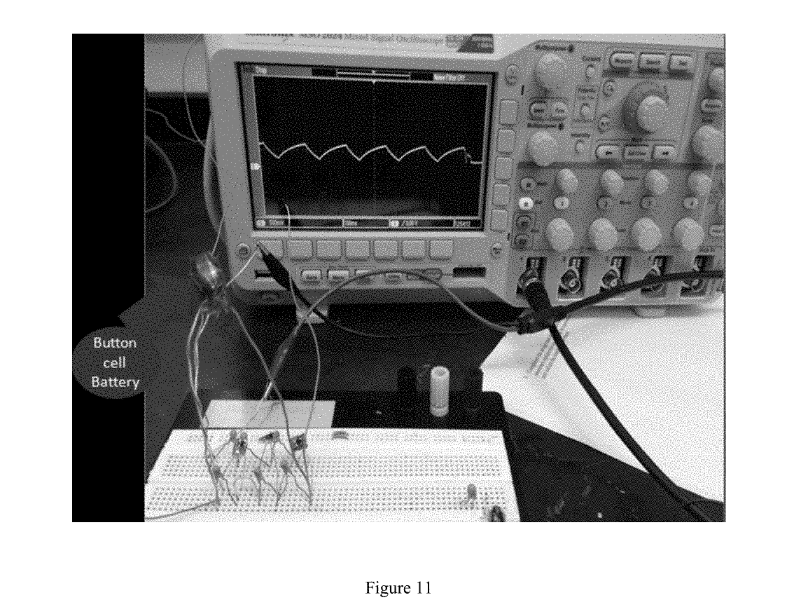

As we know that pyro-electric materials can produce 0.3˜0.8V. But max. 0.8V is not sufficient to charge battery. So we have to boost this voltage up to 1.5V. For this purpose we designed a boost converter that boost 0.4V up to 1.5V. The device is configured to connect diode D1 and D2 in series and connect D3 parallel with these two diodes. In this layout capacitor C1 is much larger than capacitor C2. At first pyro-electric voltage charges the capacitor C1 than other cascaded capacitor. After that it added voltage charge with other cascaded capacitor. In this process, we boost our pyro-electric MOS sub-Vth 0.37V to 1.45V. NVB-Trickle charging circuit setups during the hardware performance evaluation with an A76 battery are shown in FIG. 11.

Battery Function (Fully Discharged Condition)

Charger Initialization Stage

First few cycles of pyro cell will be exhibits unstable charging and test results showed very low efficiency. Where batteries test results are disclosed for document purpose only but it will not affect the charging process after few cycles. The following performance metrics are considered the actual reading condition.

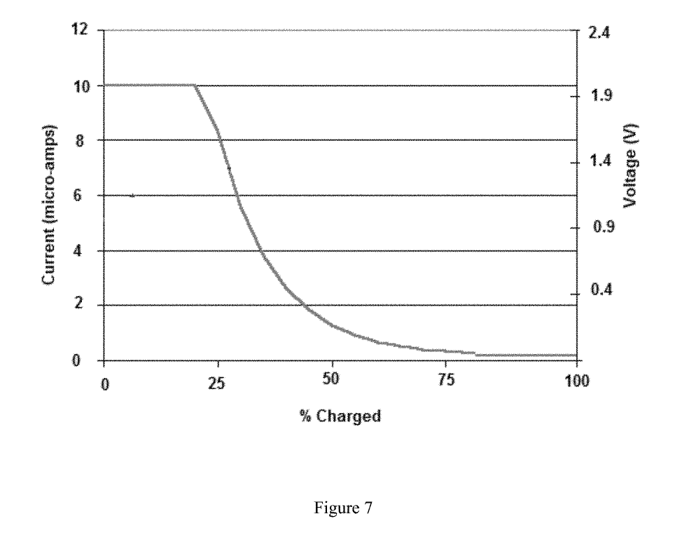

From the above FIG. 7 we can clearly see that at the one-third of the output cycle for our calculation, we got average output voltage 0.37V and average output current 34 uA. So we got output power at not fully charged condition 12.58 uW.

$${V}_{( avg \_ us \_ out )} = \frac{0.74 - 0}{2} = 0.37 V$$

$${I}_{( avg \_ us \_ out )} = \frac{75 - 7}{2} = 34 uA$$

$${P}_{( avg \_ us \_ out )} = 12.58 uW$$

At the same time we got peak-to-peak input voltage (V(pp)) is 0.74V i.e. pyro-electric voltage is 0.37V, and average input current 32 uA. So we got input power at not fully charged condition 24.05 uW

$${V}_{( pp )} = \frac{0.74 + 0.74}{2} = 0.74 V$$

$${I}_{( avg \_ us \_ in )} = \frac{110 - 45}{2} = 32.5 uA$$

$${P}_{( avg \_ us \_ in )} = 24.05 uW$$

$$Circuit power loss = 24.05 - 12.58 = 11.47 uW$$

$$Efficiency = \frac{12.58}{24.05} \times 100 = 52.3 \%$$

In this initialization stage, power loss is 11.47 uW and the efficiency is 52.3%, which occurs during the first few cycles of after start.

Battery Function at Acceptable Charged Condition (<85% Charged)

At the <85% charged condition we got average output voltage 1.25V and average output current 10 uA. So we got output power at fully charged condition 12.5 uW.

V_{(avg}_{_}ᵤₛ_{_}ₒᵤₜ₎=1.25V

I_{(avg}_{_}ᵤₛ_{_}ₒᵤₜ₎=10 uA

P_{(avg}_{_}ᵤₛ_{_}ₒᵤₜ₎=12.5 uW

At the same time we got peak-to-peak input voltage 0.74V and average input current 17 uA. So we got input power at fully charged condition 12.65 uW.

I_{(avg}_{_}ᵤₛ_{_}ᵢₙ₎=17.1 uA

P_{(avg}_{_}ᵤₛ_{_}ᵢₙ₎=12.65 uW

Circuit power loss=12.65−12.5=0.15uW

$$Efficiency = \frac{12.5}{12.65} \times 100 = 98.8 \%$$

In this acceptable charged condition, the circuit's power loss is only 0.15 uW and the efficiency is very good at 98.8%.

Battery Function at Optimum Charged Condition (>85% Charged)

At the >85% battery charged condition we got average output voltage 1.38V and average output current 3.25 uA. So we got output power at 85% battery charged condition 4.485 uW.

V_{(avg}_{_}ᵤₛ_{_}ₒᵤₜ₎=1.38V

I_{(avg}_{_}ᵤₛ_{_}ₒᵤₜ₎=3.25 uA

P_{(avg}_{_}ᵤₛ_{_}ₒᵤₜ₎=4.485 uW

At the same time we got peak-to-peak input voltage 0.74V and average input current 11.5 uA. So we got input power at 85% battery charged condition 8.51 uW.

I_{(avg}_{_}ᵤₛ_{_}ᵢₙ₎=11.5 uA

P_{(avg}_{_}ᵤₛ_{_}ᵢₙ₎=8.51 uW

In the 85% battery charged condition circuit power loss is 4.025 uW. At the 85% battery charged condition circuit efficiency is 52.7%.

Circuit power loss=8.51−4.485=4.025uW

$$Efficiency = \frac{4.485}{11.5} \times 100 = 52.7 \%$$

Battery Function at Fully Charged Condition (98.5% Charged)

At the fully charged condition we got average output voltage 1.45V and average output current 2.3 nA. So we got output power at fully charged condition 3.335 nW.

V_{(avg}_{_}ᵤₛ_{_}ₒᵤₜ₎=1.45V

I_{(avg}_{_}ᵤₛ_{_}ₒᵤₜ₎=2.3 nA

P_{(avg}_{_}ᵤₛ_{_}ₒᵤₜ₎=3.335 nW

At the same time we got average input voltage 0.74V and average input current 8.5 uA. So we got input power at fully charged condition 6.29 uW.

I_{(avg}_{_}ᵤₛ_{_}ᵢₙ₎=8.5 uA

P_{(avg}_{_}ᵤₛ_{_}ᵢₙ₎=6.29 uW

At the charged condition, delta load=Iin−Iout=17.1uA−10uA=7.1uA

Load ratio=(Vout fully charged/Vstable empty)*delta current=8.2uA

Auto-Dummy-Load (ADL) of fully charged (98.5%) battery=(6.29/0.74)*98.5%=8.3uA˜8.2uA

Circuit power loss=6.29uW−0.003335uW=6.286uW

$$Efficiency = \frac{0.003335}{6.29} \times 100 = 0.053 \%$$

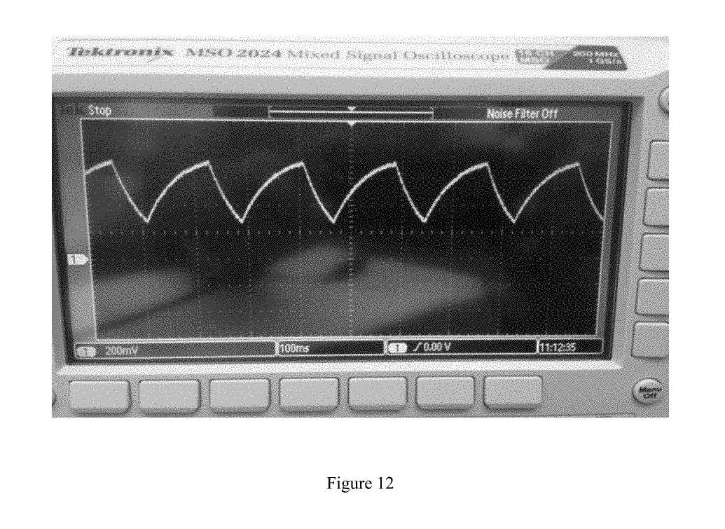

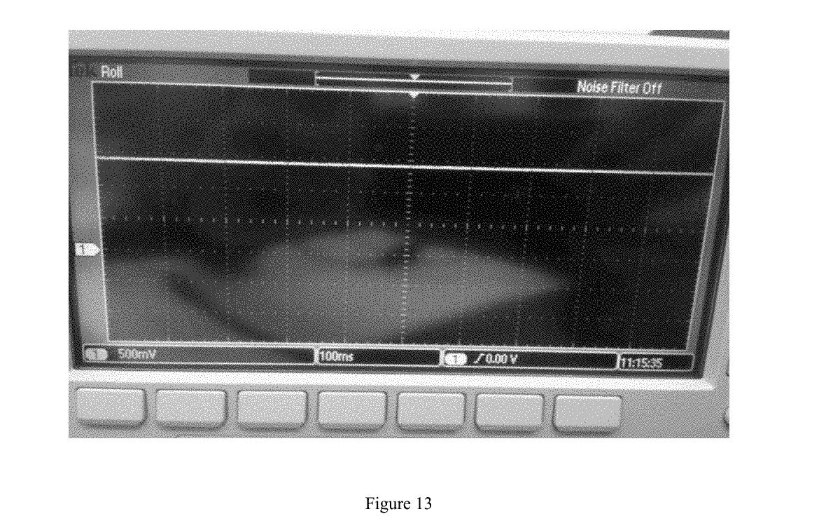

In this fully charged condition circuit power loss is 6.286 uW and it is the dummy-load at 99.95%. In this condition, circuit's charging efficiency is only 0.053% and thus it indicates for charging is completed. Please see FIG. 12 and FIG. 13.

TABLE 4.1
Condition of a battery at various charge states

| | Charge | Internal Charging | Driving |
|---|---|---|---|
| Status | capacity | Resistance | Power |
| Fully Discharged | Maximum | Minimum | Minimum |
| 85% Voltage Charged | Low medium | Medium | Normal |
| Fully-Charged 98% | Minimum | High | Very Good |

TABLE 4.2
Efficiency of NBC-TC converter during charging states

| | Output | | Input | | Circuit | | Dummy | Effi- |
|---|---|---|---|---|---|---|---|---|
| Status | Power | | Power | | Power loss | | Load | ciency |
| Fully | 12.5 | uW | 12.65 | uW | 0.15 | uW | NA | 98.8% |
| Dis- | | | | | | | | (No- |
| charged | | | | | | | | trickle) |
| Voltage | 4.485 | uW | 8.51 | uW | 4.025 | uW | NA | 52.7% |
| Charged | | | | | | | | (Less- |
| 85% | | | | | | | | trickle) |
| Fully | 3.335 | nW | 6.29 | uW | 6.286 | uW | 8.3 uA | 0.053% |
| Charged | | | | | | | | (Max- |
| 98% | | | | | | | | trickle) |

The trickle charging NVB converter circuit tested batteries in three ways when:

### 1. Battery Function (Fully Discharged Condition)

### 2. Battery Function (85% Charged Condition)

### 3. Battery Function (98.5% Fully Charged Condition)

In the fully discharged battery function we have seen no ripple voltage at the output and large output current and got maximum efficiency about 98.5%. On the other hand, at 85% fully charged battery function we got 20 mV ripple voltage at the output and low output current and got about 52.7% efficiency. Again when battery reached at 98.5% charged we got 50 mV ripple voltage at the output and very low output current and at this point efficiency very poor almost 0.053%.

The configured circuit provides that the system is able to charge a wide range and type of batteries and caps.

The disclosed device, system, and method is generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention.

Terms such as “a”, “an”, and “the” are not intended to refer to only a singular entity, but include the general class of which a specific example may be used for illustration. The terminology herein is used to describe specific embodiments of the invention, but their usage does not delimit the disclosed device or method, except as may be outlined in the claims.

Consequently, any embodiments comprising a one component or a multi-component device or system having the structures as herein disclosed with similar function shall fall into the coverage of claims of the present invention and shall lack the novelty and inventive step criteria.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific device and system described herein. Such equivalents are considered to be within the scope of this invention and are covered by the claims.

All publications, references, patents, and patent applications mentioned in the specification are indicative of the level of those skilled in the art to which this invention pertains. All publications, references, patents, and patent applications are herein incorporated by reference to the same extent as if each individual publication, reference, patent, or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of” respectively, shall be closed or semi-closed transitional phrases.

The device and system disclosed and claimed herein can be made and executed without undue experimentation in light of the present disclosure. While the device, system and methods of this invention have been described in terms of preferred embodiments, it will be apparent to those skilled in the art that variations may be applied to the device, system, and/or methods and in the steps or in the sequence of steps of the method described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

### REFERENCES

1. http://shdesigns.org/batts/battcyc.html
2. http://www.ti.com/lit/an/snva557/snva557.pdf
3. http://www.photocentric.net/comparing_rechargeable.htm
4. http://homepages.which.net/˜paul.hills/Batteries/BatteriesBody.html
5. http://www.diyelectriccar.com/forums/showthread.php/let-us-learn-hipower-corporation-41457.html
6. http://www.changhongbatteries.com/Ni-Cd_battery_for_electric_vehicle_p48_m2.1.7.html
7. http://engineering.sdsu.edu/˜hev/energy.html
8. http://www.nature.com/ncomms/journal/v4/n5/full/ncomms2932.html
9. http://wiley-vch.e-bookshelf.de/products/reading-epub/product-id/644991/title/Principles %2Band %2BApplications %2Bof%2BLithium%2BSecondary%2BBatteries.html
10. http://www.talktalk.co.uk/reference/encyclopaedia/hutchinson/m0003086.html
11. http://www.onlybatteries.com/showitem.asp?ItemID=17513.3&cat1=&uid=1448
12. http://www.knifecenter.com/item/NCCR123A/nitecore-cr123a-lithium-battery-2-pack-non-rechargeable
13. http://en.wikipedia.org/wikiBattery_%28electricity %29
14. http://www.arxterra.com/battery-comparisons/
15. http://www.all-battery.com/browseproducts/1-2-AAA-350-mAh-high-capacity-NiMH-Rechargeable-batteries-with-Tabs-%28Customized %29.html

What is claimed is:

1. A voltage boost trickle charging system for boosting a supply voltage, comprising: a circuit that provides the means for converting power from a low voltage (both zero and non-zero crossing analog) to an induced ripple DC voltage.

2. The system of claim 1, wherein said system is further configured as a clock-free, self synchronized non-inductive voltage boost converter for sub-threshold MOS voltage to sub-battery charge voltage.

3. The system of claim 1, wherein said system is further configured for controlling the ripple induction process for utilization in small battery charging.

4. The system in claim 1, wherein said system is further configured as a non-inductive voltage boost converter capable of operating at sub-threshold voltages for standard MOS.

5. The system in claim 3, wherein said system is further configured for converting μ-power pyroelectric energy to a usable voltage for charge storage devices.

6. The system of claim 1, wherein said system is further configured to prevent any leakage current by internal charge storage components in the leakage path.

7. The system of claim 5, wherein said system is further configured for a high charging efficiency greater than 98.5% at a low driving current of at least 12.7 μA that boosted to at least 1.45 VDC from a 0.37V pyroelectric source.

8. The systems of claim 1, wherein said system is further configured to be used with pyroelectric emulator systems for correlation and power verification of charge storage materials and devices.

9. The systems of claim 3, wherein said system is further configured to be used with pyroelectric emulator systems for correlation and power verification of charge storage materials and devices.

10. The systems of claim 4, wherein said system is further configured to be used with pyroelectric emulator systems for correlation and power verification of charge storage materials and devices.

11. The system of claim 1, wherein said system is further configured for inducing a self-generated load (built-in auto-dummy-load) when a target battery has reached a full charge.

12. The systems of claim 2, wherein said system is further configured to compensate charge current levels by battery's charge capacity.

13. The systems of claim 3, wherein said system is further configured to compensate charge current levels by battery's charge capacity.

14. The systems of claim 4, wherein said system is further configured to compensate charge current levels by battery's charge capacity.

15. The systems of claim 5, wherein said system is further configured to compensate charge current levels by battery's charge capacity.

16. The systems of claim 6, wherein said system is further configured to compensate charge current levels by battery's charge capacity.

17. The systems of claim 7, wherein said system is further configured to compensate charge current levels by battery's charge capacity.

18. The system of claim 1, wherein said system is further configured where the amount of ripple effect is auto-adjusted based on the battery reaching peak of its voltage and internal resistance.

19. The system of claim 1, wherein said systems are further configured as a semiconductor IC having internally cascading capable mechanisms with external adjustable ripple controller.

20. The system of claim 2, wherein said systems are further configured as a semiconductor IC having internally cascading capable mechanisms with external adjustable ripple controller.
